(19) United States
(12) Patent Application Publication
(10) Pub. No.: US 2014/0153140 A1
(43) Pub. Date: Jun. 5, 2014

(54) Overvoltage Protection

(71) Applicant: Control Techniques Limited, Newtown (GB)

(72) Inventors: Simon David Hart, Welshpool (GB); Antony John Webster, Montgomery (GB); Kondala Rao Gandu, Newtown (GB)

(73) Assignee: CONTROL TECHNIQUES LIMITED, Newtown (GB)

(21) Appl. No.: 14/093,670

(22) Filed: Dec. 2, 2013

(30) Foreign Application Priority Data
Nov. 30, 2012 (GB) 1221573.7

(51) Int. Cl. H02H 3/20

(52) U.S. Cl. CPC H02H 3/20
USPC 361/18; 361/91.1

(57) ABSTRACT

A power supply arranged to charge a smoothing capacitance via a resistive element for soft-starting in the event that one or more conditions for normal operation are not complied with is arranged to detect that a voltage across at least part of the smoothing capacitance exceeds an excess voltage threshold and, responsive to the detecting, interrupt charging of the smoothing capacitance via the resistive element for soft-starting.

### CROSS-REFERENCE TO RELATED APPLICATION

This application claims the benefit and priority of Great Britain Patent Application No. 1221573.7, filed Nov. 30, 2012. The entire disclosure of the above application is incorporated herein by reference.

### FIELD

This disclosure relates to overvoltage protection. In particular, but without limitation, this disclosure relates to overvoltage protection for electrical drives and power supplies.

### BACKGROUND

Electrical power can be provided for use in the form of a Direct Current (DC) voltage and also in the form of a Alternating Current (AC) voltage that has been rectified by applying an AC voltage waveform to a half- or full-wave rectifier so as to produce a rectified voltage. Power supplies receiving as an input rectified or DC voltages may employ a smoothing capacitance in order to reduce output voltage ripple by releasing stored energy at points when the input supply is providing reduced or no power.

### SUMMARY

Aspects and features of the present disclosure are set out in the appended claims.

In an example apparatus, an overvoltage protection circuit has first and second power input connections for connection to a rectified or DC voltage source. A soft-start module has an input coupled to the second power input connection and has a pair of circuit legs arranged to interruptibly connect the input of the module and its output. One of the legs is for normal operation and connects the input of the module to its output only once one or more predetermined operating conditions have been complied with. The other leg is for “soft-starting” and has a resistor for limiting current flow. The circuit has a smoothing capacitance connected between the first power input and the output of the soft-start module and an overvoltage detector arranged to detect a voltage across all or part of the smoothing capacitance and interrupt, or break the connection between the soft-start module's input and output via the leg for soft-starting in the event that the detected voltage exceeds an excess voltage threshold.

The overvoltage detector may be further arranged so that, once it has interrupted the connection between the soft-start module's input and output via the leg for soft-starting, it continues to do so until the detected voltage falls below a safe operating voltage threshold—which may be lower, or have a smaller magnitude than the excess voltage threshold.

The overvoltage detector may be further arranged so that, once it has interrupted the connection between the soft-start module's input and output via the leg for soft-starting, it continues to do so until a predetermined time has elapsed since the interruption commenced.

In an example method, a voltage across all or part of a smoothing capacitance is monitored and, when it is determined that the monitored voltage has exceeded an excess voltage threshold, a switch is activated to interrupt a circuit leg connected to the smoothing capacitance to prevent the smoothing capacitance charging up via that circuit leg. The method may also involve continuing to interrupt the circuit leg until one or both of: the monitored voltage has fallen below a safe operating voltage threshold; and a predetermined time period has elapsed since the circuit leg was initially interrupted.

Advantageously if a device comprising the overvoltage protection circuit described herein is inadvertently connected to an input voltage that is higher than the excess voltage threshold, the input voltage is disconnected and so the smoothing capacitance is not subjected to overvoltage for a sustained period thereby reducing the chances of the capacitor breaking down and causing smoke and/or fire. Furthermore, as a capacitor in the process of breaking down can draw a significant amount of current, the soft-start resistor will not be subject to such a potentially damaging current.

By enabling a reduction in the risk of fire in the event that a device comprising the overvoltage protection circuit is connected to an excessively high voltage supply, the overvoltage protection circuit reduces the incidence of accidental user damage and avoids the potential embarrassment that can be caused by a user damaging a device by accidentally connecting it to an excessively high voltage supply. Also, knowing that devices containing the overvoltage protection circuit are less likely to ignite provides users with greater confidence in those devices.

### DRAWINGS

Examples of the present disclosure will now be explained with reference to the accompanying drawings in which:

FIG. 1 shows an exemplary circuit diagram of an exemplary overvoltage protection circuit;

FIG. 2 shows a flow chart illustrating the operation of an exemplary overvoltage protection circuit; and

FIG. 3 shows a further exemplary circuit diagram of an overvoltage protection circuit.

### DETAILED DESCRIPTION

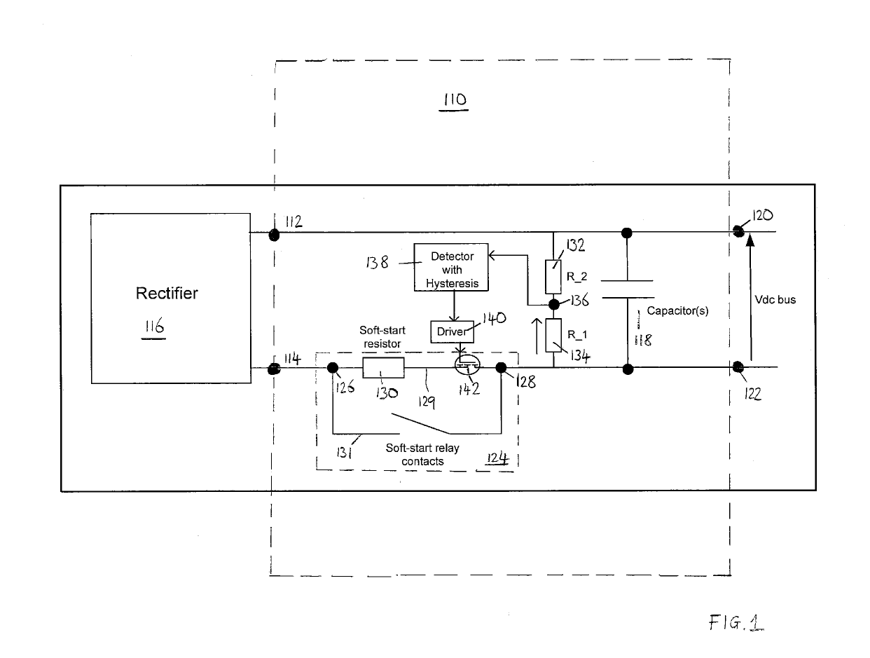

FIG. 1 shows an exemplary circuit diagram of an overvoltage protection circuit 110 connected via first 112 and second 114 power input connections to a rectifier 116. The overvoltage protection circuit 110 further comprises output connectors 120, 122 which together form a DC output voltage bus. A smoothing capacitance 118 is coupled between the first power input connector 112 and the second output connector 122 and is arranged, upon connection of a voltage between the first and second power input connections 112, 114 to charge up via a soft-start module 124.

Soft-start module 124 comprises a soft-start input point 126 and a soft-start output 128. An interruptible circuit leg for soft-starting 129 connects the soft-start input 126 and the soft-start output 128 and comprises a soft-start resistor 130 and a semiconductor switch 142. The soft-start module 124 further comprises an interruptible circuit leg for normal operation 131 that connects to the soft-start input 126 and the soft-start output 128 and comprises soft-start relay contacts that may be opened or closed depending upon circuit conditions. When a voltage is initially applied to the first and second power input connections 112, 114, the smoothing capacitance 118 starts to charge up via the soft-start resistor 130 which is sized to limit the amount of current that the capacitor can draw as it charges up. Once circuit conditions are such that the capacitor may operate under normal conditions, the relay (not shown) is activated so as to close the relay contacts of the circuit leg for normal operation 131 and thereby short circuit the soft-start input point 126 to the soft-start output 128 so that the current flows through the circuit leg for normal operation 131 instead of through the circuit leg for soft-starting 129 and its soft-start resistor 130. Exemplary circuit conditions that can be used to determine that it is appropriate to stop using the circuit leg for soft-starting 129 include a determination that the rate of change of voltage across the smoothing capacitance 118 is below a predetermined threshold or a determination that a predetermined time period has elapsed since connection of a voltage source to the first and second power input connections 112, 114. For simplicity, no apparatus for detecting the conditions used to determine that it is appropriate to stop using the circuit leg for soft-starting 129 is shown in FIG. 1.

The overvoltage protection circuit 110 further comprises a potential divider formed of a pair of resistors 132, 134 and arranged to divide the potential difference across the smoothing capacitance 118. The combined resistance of the pair of resistors 132, 134 is preferably high so as to reduce the power consumption of the pair of resistors 132, 134. An output voltage is taken from an output point 136 in the potential divider and provided to a detector 138. The detector 138 is arranged to detect when the voltage at the output point 136 of the potential divider is such that the potential difference across the smoothing capacitance 118 is in excess of a predetermined excess voltage threshold (or trip level). The excess voltage threshold is selected so as to be higher than the maximum voltage permitted for normal operation of the apparatus that is to be, or is, connected to the output connectors 120, 122 (e.g. a drive), but less than the level at which the smoothing capacitance 118 will suffer damage. Once the detector 138 detects that the voltage at output point 136 is such that the excess voltage threshold has been exceeded, the detector 138 sends a drive signal to driver 140 which then activates the semiconductor switch 142, in this case a Field Effect Transistor (FET), thereby causing an open circuit to occur between the soft-start resistor 130 and the soft-start output 128 in the circuit leg for soft-starting 129 and therefore also an open circuit between the second input power connector 114, which may itself be connected to the negative rail of a rectifier, and the smoothing capacitance 118.

The inventor has appreciated that, if the detector 138 uses only a single voltage threshold to determine whether or not to interrupt the semiconductor switch 142 then the semiconductor switch 142 can, under certain circumstances, turn on and off in rapid succession. When the semiconductor switch 142 is a FET, rapid turning on and off can cause non-linear, and therefore lossy, operation of the FET. When a FET operates non-linearly for a sustained period, the consequent losses may cause the FET to rapidly heat up and possibly blow. Also, it has been observed that electrolytic capacitors do not react favourably to being repeatedly charged and discharged in rapid succession as the friction caused by the movement of the electrolytes consequent to such rapid charging and discharging can cause the capacitor to rapidly heat up to a point where the electrolyte boils and may evaporate thereby reducing the effective capacitance of the capacitor and increasing voltage ripple.

Accordingly, in the example of FIG. 1, in addition to being able to detect when the voltage at the output point 136 of the potential divider is such that the potential difference across the smoothing capacitance 118 is in excess of the excess voltage threshold, the detector 138 is also able to detect when the voltage at the output point 136 of the potential divider is such that the potential difference across the smoothing capacitance 118 is lower than a predetermined safe operating voltage threshold for the smoothing capacitance and/or any load that is, or is to be, connected to the output connectors 120, 122. Furthermore, the detector 138 is arranged so that once it has detected that the predetermined excess voltage threshold has been exceeded, it continues to send the drive signal to the driver 140 until it detects that the voltage at the output point 136 of the potential divider is such that the potential difference across the smoothing capacitance 118 is lower than the predetermined safe operating voltage. As explained above, sending the drive signal to driver 140 activates the semiconductor switch 142 thereby causing an open circuit to occur between the soft-start resistor 130 and the soft-start output 128 in the circuit leg for soft-starting 129. The combined usage of the excess voltage threshold and the safe operating voltage threshold provides the detector 138 with hysteresis and so allows the smoothing capacitance 118 to discharge via the potential divider and any load impedance coupled to the output connectors 120, 122. Advantageously, by providing the detector with different turn-on and turn-off thresholds, the semiconductor switch 142 is less likely to turn on and off in rapid succession thereby protecting the semiconductor switch 142 and the smoothing capacitance 118.

The inventor has further appreciated that, even if the detector 138 is provided with hysteresis, operating circumstances may nevertheless occur which would cause the semiconductor switch 142 to turn on and of rapidly and consequently potentially damage the semiconductor switch 142 and/or smoothing capacitance 118. An example of such circumstances would be where the voltage provided between the input power terminals 112, 114 rapidly sawtoothes between a voltage below the safe operating voltage threshold and a voltage above the excess voltage threshold. In order to avoid such circumstances, the detector 138 of the overvoltage protection circuit 110 of FIG. 1 is further arranged so that, once it has been detected that the excess voltage threshold has been exceeded, the detector 138 continues to send the drive signal to the driver 140 until at least a predetermined time interval has elapsed since the detector 138 initially determined that the excess voltage threshold had been exceeded. As one possibility, the time duration may be set so as to be comparable with the time required for the smoothing capacitance 118 to discharge from the excess voltage threshold to the safe operating voltage threshold via the impedance of the potential divider and any load impedance that is connected between the output terminals 120, 122. Advantageously, waiting a predetermined time period after the circuit leg for soft-starting 129 has been interrupted before ceasing the interruption, enables control of the maximum turn-on turn-off frequency that both the semiconductor switch 142 and the smoothing capacitance 118 can be subjected to.

If the voltage across the smoothing capacitance 118 has discharged to below the safe operating voltage threshold and the predetermined time period since the circuit leg for soft-starting 129 was interrupted has passed and the semiconductor switch is closed so as to close circuit the circuit leg for soft-starting 129 but the potential difference between the power input connections 112, 114 remains, or is again, above the excess voltage threshold, the circuit leg for soft-starting 129 will only be close circuited briefly as the detector 138 will then again drive the semiconductor switch 142 to interrupt, and thereby open circuit, the circuit leg for soft-starting 129.

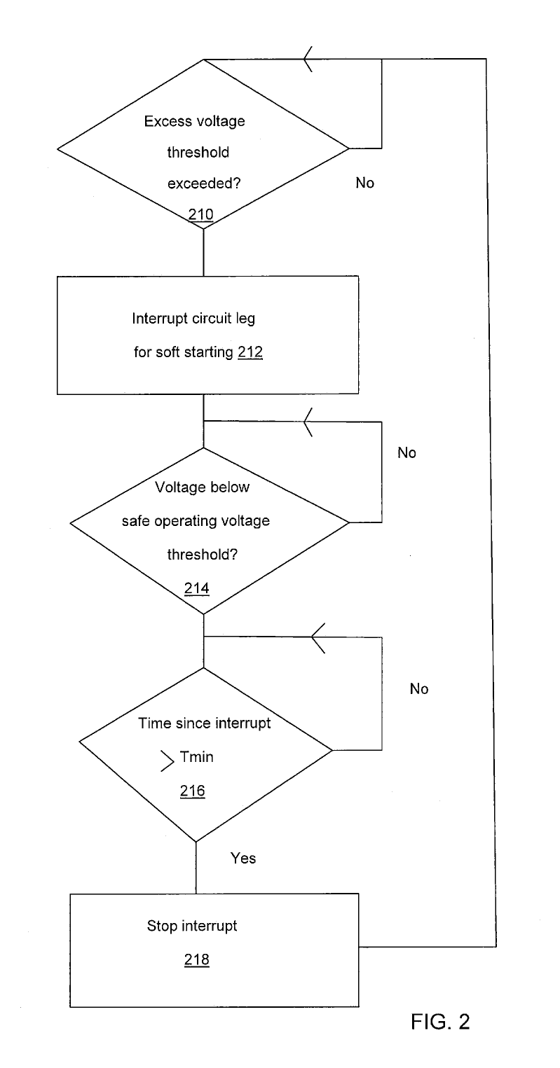

FIG. 2 shows a flow chart illustrating the operation of an exemplary overvoltage protection circuit. At step 210, the process checks whether the voltage across the smoothing capacitor is such that the excess voltage threshold has been exceeded. If the excess voltage has not been exceeded then the process repeats step 210. If the excess voltage threshold has been exceeded then, at step 212, the circuit leg for soft-starting 129 is interrupted. At step 214 a check is made as to whether the voltage across the smoothing capacitor is below the safe operating voltage threshold. If the voltage is not below the safe operating voltage threshold then the process repeats step 214. If the voltage is below the safe operating voltage threshold, then the process proceeds to step 216 where it is determined whether the time that has elapsed since the circuit leg for soft-starting 129 was initially interrupted is greater than a minimum turn-off time (Tₘᵢₙ). If the time that has elapsed since the circuit leg for soft-starting 129 was initially interrupted is less than Tₘᵢₙ, the process repeats step 216. If the time that has elapsed since the circuit leg for soft-starting 129 was initially interrupted is greater than Tₘᵢₙ then, at step 218, the interruption of the circuit leg for soft-starting 129 is stopped and the process returns to step 210. A person skilled in the art will recognise that steps 214 and 216 of the method of FIG. 2 could be transposed or combined.

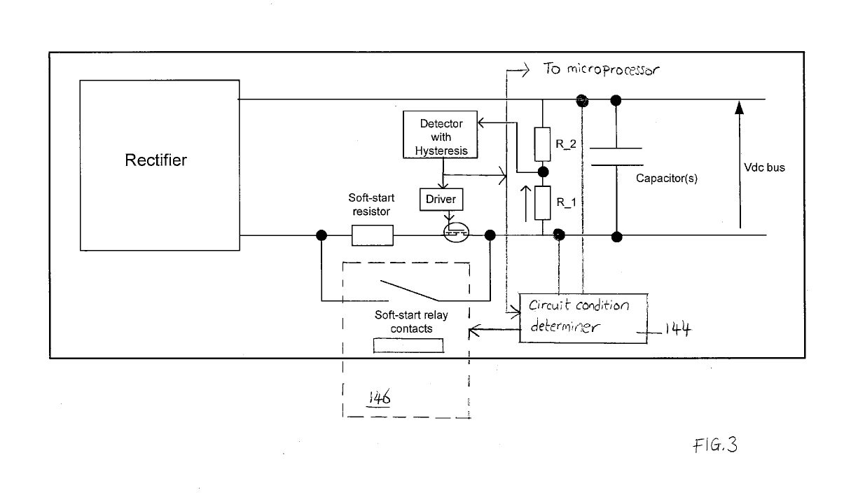

FIG. 3 shows a further exemplary circuit diagram of a voltage over protection circuit 110 and, where appropriate, uses reference numerals like for those in FIG. 1. In particular, FIG. 3 shows a circuit condition determiner 144 having inputs on either side of the smoothing capacitance 118 and being arranged to detect when the rate of change of voltage across the smoothing capacitance 118 falls below a predetermined value. When the rate of change of voltage across the smoothing capacitance 118 falls below the predetermined value, the circuit condition determiner 144 energises the coils of a soft-start relay 146 so as to stop the interruption of the circuit leg for normal operation 131 that would otherwise be caused by the air gap between the contacts of the soft-start relay 146. In FIG. 3, it can also be seen that the output of the detector 138 is provided to the circuit condition determiner 144 so as to inform the circuit condition determiner 144 that the excess voltage threshold has been exceeded and so the circuit condition determiner 144 should not energise the coils of the soft-start relay 146. Furthermore, FIG. 3 shows that the output of the detector 138 is also provided to a microprocessor (not shown) for informing a user that an overvoltage issue has occurred and/or logging the occurrence. As another possibility, a microprocessor may take a signal directly from the output point 136 of the potential divider and use that signal as a trigger for informing a user that an overvoltage issue has occurred and/or logging the occurrence.

In circumstances where the semiconductor switch is a FET, as the FET is in series with the soft-start resistor 130 and within circuit leg for soft-starting 129 that will be bypassed once the soft-start relay 146 has closed during normal operation, the FET passes no current after a soft-start has been completed and so advantageously consumes no power. Considerations when selecting a FET for use as the semiconductor switch 142 include the size of the charging current that is expected to pass through the soft-start resistor 130 and the maximum soft-start charging time.

As one possibility, the time required for the smoothing capacitance 118 to discharge from the excess voltage threshold to the safe operating voltage threshold via the impedance of the potential divider and any load impedance that is connected between the output terminals 120, 122 of the overvoltage protection circuit 110 is set, by choice of the values of one or more of those impedances and the smoothing capacitance 118, so as to provide sufficient time for the power supplies of any microprocessors that are powered by the DC voltage bus and that are connected to the detector 138 and/or the potential divider to become active and for the microprocessors to be able to provide an alert to notify users of the situation.

A person skilled in the art will appreciate that the smoothing capacitance may comprise a plurality of discrete or integrated components having in combination a capacitance suitable for providing a smoothing functionality. For example, the smoothing capacitance may comprise a plurality of capacitors arranged in series and/or parallel so as to form a bank of capacitors. Furthermore, the smoothing capacitance may comprise one or more electrolytic capacitors.

The overvoltage detectors described herein may be arranged to detect a voltages across the whole or a part of the smoothing capacitance. For example, in the event that the smoothing capacitance comprises a pair of capacitors in series, the overvoltage detector may be arranged to detect the potential difference across only one of the capacitors. Furthermore, the overvoltage detectors described herein may be arranged to detect voltages either directly or indirectly. For example, in FIG. 1 the overvoltage detector 138 is employed along with two resistors 132, 136 which act as a potential divider that divides the voltage across the smoothing capacitor 118 so that the voltage provided to the overvoltage detector 138 from the output point 136 of the potential divider is a fraction of the potential difference across the smoothing capacitor 118. Accordingly, the overvoltage detector 138 need not directly sense the voltage across the smoothing capacitor 118 in order to determine whether the voltage thereacross is above the excess voltage threshold or below the safe operating voltage threshold. In circumstances where the overvoltage detector 138 does not directly sense the voltage across the smoothing capacitor 118, the voltage received by the overvoltage detector may be a fraction of the potential difference across the smoothing capacitor 118 and so the overvoltage detector detects when the voltage that it receives exceeds an excess voltage threshold that is a fraction of the excess voltage threshold that has been predetermined for the smoothing capacitance 118. Likewise, in such circumstances the overvoltage detector detects when the voltage that it receives is less than a safe operating voltage threshold that is a fraction of the safe operating voltage threshold that has been predetermined for the smoothing capacitance 118.

As one possibility, the soft-start input point 126 may be connected to a negative or ground rail of a rectified or DC voltage source and the detector and any microprocessor(s) may also be powered by voltage sources referenced relative to the negative or ground rail of the DC voltage output. Advantageously, in such circumstances there is no requirement for a voltage level shift between the output of the detector 138 or the output point 136 of the potential divider and the microprocessor(s).

Although the above has been described with reference to a detector having hysteresis, a person skilled in the art will appreciate that the detector does not need to have hysteresis and could alternatively be a detector arranged to open circuit the soft-start circuit leg of the soft-start module in circumstances where the excess voltage threshold has been exceeded. A person skilled in the art would further understand that as one possibility the detector may have hysteresis, but no time delay functionality, and so may open circuit the soft-start circuit leg of the soft-start module once the excess voltage threshold has been received and continue to open circuit the soft-start circuit leg of the soft-start module until the safe operating voltage threshold has been reached. As another possibility, the detector may be arranged to open circuit the soft-start circuit leg of the soft-start module once the excess voltage threshold has been exceeded and to maintain that open circuit until a predetermined time has passed since the soft-start circuit leg was open circuited.

Although the detector 138 and/or the driver 140 may comprise one or more Integrated Circuits (ICs), such as a comparator chip, as another possibility, the detector 138 and/or the driver 140 do not comprise any ICs and are instead formed from discrete components such as a Zener diode network, capacitors and/or resistors. A person skilled in the art would, or course, have no difficulty in implementing the functionality of the detector and/or driver as described herein when using either ICs or discrete components. Advantageously, if the detector 138 and/or the driver 140 do not comprise ICs, they may be arranged to have very small power consumptions and may not require a separate power supply as ICs often do. For example, a capacitor may be used to provide the detector with sufficient power to operate once the rectified or DC voltage source has been open circuited from the overvoltage protection circuit.

Although the above has been described with reference to the semiconductor switch being a FET, a person skilled in the art will appreciate that other semiconductor switches may be employed for example, a Bipolar Junction Transistor (BJT), a Junction FET (JFET), an Insulated Gate FET (IGFET), a Metal Oxide Semiconductor FET (MOSFET), a Metal Semiconductor FET (MFET), etc.

Although the above has described the use of a semiconductor switch for interrupting the circuit leg for soft starting, as one possibility another type of interrupting device, for example a relay could be employed instead of, or as well as, the semiconductor switch.

Although the above has described the detector and the circuit conditioner determiner as separate entities, they could also be combined and their individual or combined functionality may be provided by a microprocessor, possibly along with suitable drive and input electronics. Further, the methods described herein may be controlled and/or carried out by a computer and may be embodied in a computer readable medium carrying machine readable instructions arranged, upon execution by a processor, to cause the processor to carry out any of the methods described herein.

The overvoltage circuit described herein may be incorporated or included in an electric drive or power supply. In one example the smoothing capacitance may be connected so that some or all of the potential difference thereacross is tapped off to provide a DC voltage bus for a drive or power supply. As one possibility, the side of the smoothing capacitance that is connected to the soft-start module may provide the ground, or negative, voltage rail of the bus and the other side of the smoothing capacitance, or a tapping from an intermediate point in the smoothing capacitance, may provide the positive voltage rail of the bus. Although the above has been described with reference to the circuit leg for normal operation comprising soft-start relay contacts that are moveable by energisation of a relay, a person skilled in the art will appreciate that alternative or additional means of interrupting the circuit leg for normal operation could equally be employed, for example, a semiconductor switch.

Although the above has described the overprotection circuit as being supplied by a voltage output by a rectifier, a person skilled in the art would understand that the overprotection circuit described herein may, as an alternative to being supplied with a rectified DC voltage, instead be supplied by a DC voltage, for example a DC voltage that ripples.

Although the above has in places described the connection of the soft-start module to the negative or ground rail of a rectified or DC voltage source, a person skilled in the art would appreciate that the positive rail of a rectified or DC voltage source could instead be connected to power input connection 114 and the negative or ground rail of the rectified or DC voltage source connected to power input connection 112.

A person skilled in the art will appreciate that the circuit condition determiner may be arranged to cause interruption of the circuit leg for normal operation in the event that one or more of the conditions for normal operation are not complied by either sending or not sending a signal to control interruption of circuit leg for normal operation. Likewise, the skilled person would also understand that the overvoltage detector be arranged to cause interruption of the circuit leg for soft-starting by either sending or not sending a signal to control interruption of circuit leg for normal operation.

A person skilled in the art will appreciate that references herein to electrical components connected or coupled to other electrical components refer to an arrangement of those components so that an electrical current can flow therebetween. A skilled person will likewise appreciate that reference herein to interruption of a circuit portion or leg relate to an action that impedes or prevents the flow of electrical current in that circuit portion or leg.

1. An overvoltage protection circuit comprising:
first and second power input connections for connection to a rectified or DC voltage source;
a soft-start module having:
a soft-start module input coupled to the second power input connection,
a soft-start module output,
a circuit leg for soft-starting connected between the soft-start module input and the soft-start module output and comprising a resistive element, and
a circuit leg for normal operation connected between the soft-start module input and the soft-start module output;
a smoothing capacitance coupled to the first power input connection and the soft-start module output;
a circuit condition determiner arranged to determine whether one or more conditions for normal operation are complied with and to cause interruption of the circuit leg for normal operation in the event that one or more of the conditions for normal operation are not complied with; and
an overvoltage detector arranged to detect a voltage across at least part of the smoothing capacitance and to cause interruption of the circuit leg for soft-starting in the event that the detected voltage exceeds an excess voltage threshold.

2. The overvoltage protection circuit of claim 1, wherein the overvoltage detector is further arranged, once it has caused interruption of the circuit leg for soft-starting, to continue to cause interruption of the circuit leg for soft-starting until the detected voltage falls below a safe operating voltage threshold.

3. The overvoltage protection circuit of claim 2, wherein the safe operating voltage threshold has a smaller magnitude than the excess voltage threshold.

4. The overvoltage protection circuit of claim 1, wherein the overvoltage detector is further arranged, once it has caused interruption of the circuit leg for soft-starting, to continue to cause interruption of the circuit leg for soft-starting until a predetermined time period has passed since the detector started to cause interruption of the circuit leg for soft-starting.

5. The overvoltage protection circuit of claim 1, wherein the smoothing capacitance comprises one or more capacitors.

6. The overvoltage protection circuit of claim 5, wherein at least one of the one or more capacitors is an electrolytic capacitor.

7. The overvoltage protection circuit of claim 1, wherein the circuit leg for normal operation comprises a relay and the circuit condition determiner is operable to cause interruption of the circuit leg for normal operation by controlling the relay.

8. The overvoltage protection circuit of claim 1, wherein the circuit leg for soft-starting comprises a semiconductor switch and the overvoltage detector is operable to cause interruption of the circuit leg for soft-starting by controlling the semiconductor switch.

9. The overvoltage protection circuit of claim 8, wherein the semiconductor switch is a Field Effect Transistor, FET.

10. The overvoltage protection circuit of claim 1, wherein the resistive element is a resistor.

11. A drive or power supply comprising the overvoltage protection circuit claim 1 wherein the circuit is arranged so that the first power input connection and the soft-start module output act as a DC voltage bus with the first power input connection providing the positive voltage rail of the DC voltage bus and the soft-start module output providing the ground, or negative, voltage rail of the bus.

12. A method for providing overvoltage protection in an overvoltage protection circuit arranged to charge a smoothing capacitance via a resistive element for soft-starting in the event that one or more conditions for normal operation are not complied with, the method comprising:
detecting that a voltage across at least part of the smoothing capacitance exceeds an excess voltage threshold; and
responsive to the detecting, interrupting charging of the smoothing capacitance via the resistive element for soft-starting.

13. The method of claim 12, further comprising continuing to interrupt charging of the smoothing capacitance via the resistive element for soft-starting until the voltage across at least part of the smoothing capacitance falls below a safe operating voltage threshold.

14. The method of claim 13, wherein the safe operating voltage threshold has a smaller magnitude than the excess voltage threshold.

15. The method of claim 12, further comprising continuing to interrupt charging of the smoothing capacitance via the resistive element for soft-starting until a predetermined time period has passed since interruption started.

16. A computer readable medium carrying machine readable instructions arranged upon execution by a processor to cause the processor to carry out the method of claim 12.

17. (canceled)
